(19) United States
(12) Patent Application Publication
(10) Pub. No.: US 2026/0339869 A1
(43) Pub. Date: Oct. 29, 2026

(54) Method and Apparatus for Managing Non-Transparent Bridge, and Controller and Medium

(71) Applicant: SUZHOU METABRAIN INTELLIGENT TECHNOLOGY CO., LTD., Suzhou, Jiangsu (CN)

(72) Inventors: Ji ZHONG, Suzhou, Jiangsu (CN); Lupan WANG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/111,560

(22) PCT Filed: Mar. 10, 2023
(86) PCT No.: PCT/CN2023/080892

§ 371 Date: Mar. 13, 2025

(30) Foreign Application Priority Data
Sep. 13, 2022 (CN) 202211107200.8

(51) Int. Cl. G06F 13/40

(52) U.S. Cl. CPC G06F 13/4027; G06F 2213/40

(57) ABSTRACT

A method and apparatus for managing non-transparent bridge, and a controller and a non-transitory medium are provided. The method includes: partitioning data to be backed up and distributing channels for each region; continuously sending data to first non-transparent bridges connected to a main controller through all the channels of each region such that the first non-transparent bridges respectively perform continuity verification on received data corresponding to each region; and acquiring a first verification result returned by the first non-transparent bridges, and if the first verification result is that a region does not pass the continuity verification, enumerating and verifying all the channels of the region.

### CROSS-REFERENCE TO RELATED APPLICATION

This application claims priority to Chinese Patent Application No. 202211107200.8 filed to the China National Intellectual Property Administration on Sep. 13, 2022 and entitled “Method and Apparatus for Managing Non-Transparent Bridge, and Controller and Medium”, the disclosure of which is hereby incorporated by reference in its entirety.

### Technical Field

The present disclosure relates to the technical field of storage, and in particular, to a method and apparatus for managing non-transparent bridge, and a controller and a non-transitory readable storage medium.

### BACKGROUND

In the era of big data, higher requirements are proposed on the reliability of storage arrays, especially on the reliable stability of data backup of storage systems. A current storage system uses Non-Transparent Bridging (NTB) to realize data backup between dual controllers, so as to ensure that data processed on the dual controllers may be rapidly and accurately backed up, and the reliability of a storage device is greatly improved by using such mirror backup. However, in a process of using a non-transparent bridge chip to realize data backup, a controller is connected to the NTB chip for data transmission through a Peripheral Component Interconnect Express (PCIE) channel. Furthermore, as a current PCIE technology develops, bandwidths required for transmitting and backing up data are gradually increased, and with the complexity of storage mainboard functions, a length of a data transmission channel is also prolonged to a certain extend. All of these physical factors make it more difficult to transmit data over the PCIE channel for backup. Therefore, how to accurately and rapidly perform NTB verification management to ensure an accurate and correct data backup process is an urgent problem to be solved currently.

### SUMMARY

Disclosed in the present disclosure is a method for managing non-transparent bridge, which is applied to a main controller in a dual controller, and includes: data to be backed up is partitioned and channels are distributed for each region; data is continuously sent to first non-transparent bridges connected to a main controller through all the channels of each region such that the first non-transparent bridges respectively perform continuity verification on received data corresponding to each region; and a first verification result returned by the first non-transparent bridges is acquired, and if the first verification result is that a region does not pass the continuity verification, all the channels of the region are enumerated and verified.

In some embodiments of the present disclosure, partitioning the data to be backed up and distributing the channels for each region includes: horizontal partitioning is performed on the data to be backed up according to data service object, so as to obtain each region; vertical partitioning is performed on the data to be backed up according to a data importance degree, so as to obtain each vertical partition; and the channels are distributed for each region based on a data volume of each region in each vertical partition.

In some embodiments of the present disclosure, performing horizontal partitioning on the data to be backed up according to the data service object, so as to obtain each region includes: the data service object is acquired from a front-end server; and horizontal partitioning is performed on the data to be backed up according to the data service object, so as to obtain each region.

In some embodiments of the present disclosure, the method further includes: if the first verification result is that each region passes the continuity verification, data backup is started, and the data to be backed up is backed up to a backup controller in the dual controller according to each region through the channels of each region.

In some embodiments of the present disclosure, after partitioning the data to be backed up and distributing the channels for each region, the method further includes: a partition and channel distribution situation is sent to the backup controller such that the backup controller continuously sends data to second non-transparent bridges connected to the backup controller through all the channels of each region based on the partition and channel distribution situation, so as to cause the second non-transparent bridges to respectively perform the continuity verification on received data corresponding to each region, and to enumerate and verify all the channels of a region when a second verification result returned by the second non-transparent bridges is that the region does not pass the continuity verification.

In some embodiments of the present disclosure, if the first verification result is that each region passes the continuity verification, starting data backup includes: if the first verification result is that each region passes the continuity verification, and the second verification result is that each region passes the continuity verification, data backup is started.

In some embodiments of the present disclosure, enumerating and verifying all the channels of the region includes: the data is continuously sent to the first non-transparent bridges connected to the main controller one by one through the channels of the region such that the first non-transparent bridges respectively perform the continuity verification on the received data corresponding to each channel.

In some embodiments of the present disclosure, backing up the data to be backed up to the backup controller in the dual controller according to each region through the channels of each region includes: the data to be backed up is batched to obtain a plurality of pieces of batch data, and the plurality of pieces of batch data are backed up to the backup controller in the dual controller batch by batch according to each region through the channels of each region. Correspondingly, the method further includes: after any batch data is backed up, a first feature of the batch data is extracted, and the first feature is transmitted to the first non-transparent bridge such that the first non-transparent bridge compares whether the first feature is consistent with a second feature, where the second feature is a second feature of the batch data received by the backup controller extracted by the backup controller.

In some embodiments of the present disclosure, the method further includes: an execution instruction is sent to the backup controller such that the backup controller extracts the second feature of the received batch data under control of the execution instruction.

In some embodiments of the present disclosure, the method further includes: the second feature sent by the backup controller is acquired; and the second feature is transmitted to the first non-transparent bridge such that the first non-transparent bridge compares whether the first feature is consistent with the second feature.

In some embodiments of the present disclosure, the method further includes: if the first feature is inconsistent with the second feature, a problematic channel is determined, and the problematic channel is closed.

In some embodiments of the present disclosure, determining the problematic channel includes: data is continuously sent to the first non-transparent bridges connected to the main controller through all the channels of each region such that the first non-transparent bridges respectively perform the continuity verification on the received data corresponding to each region; and a verification result returned by the first non-transparent bridges is acquired, if the verification result is that a region does not pass the continuity verification, all the channels of the region are enumerated and verified, and a channel that does not pass the verification is determined as the problematic channel.

In some embodiments of the present disclosure, extracting the first feature of the batch data includes: a hash function is determined; and the hash function is used to extract a hashed value set of the batch data, so as to obtain the first feature of the batch data.

In some embodiments of the present disclosure, determining the hash function includes: a data type of the batch data is recognized; and the hash function is determined based on the data type.

In some embodiments of the present disclosure, using the hash function to extract the hashed value set of the batch data, so as to obtain the first feature of the batch data includes: for any data type of data in the batch data, a hashed value is extracted by using the hash function corresponding to the data type; and hashed values corresponding to different data types are fused into the hashed value set of the batch data, so as to obtain the first feature of the batch data.

In some embodiments of the present disclosure, the data type includes a text type, an image type, and a video type, and accordingly, determining the hash function based on the data type includes: a first hash function is constructed based on a division method; a hash function of the text type is determined as the first hash function; a second hash function is constructed based on a square median method; and hash functions of the image type and the video type are determined as second hash functions.

Disclosed in the present disclosure is an apparatus for managing non-transparent bridge, which is applied to a main controller in a dual controller, and includes: a data partitioning component, configured to partition data to be backed up; a channel distribution component, configured to distribute channels for each region; a partition verification component, configured to continuously send data to first non-transparent bridges connected to the main controller through all the channels of each region such that the first non-transparent bridges respectively perform continuity verification on received data corresponding to each region; a verification result acquisition component, configured to acquire a first verification result returned by the first non-transparent bridges; and a channel verification component, configured to, if the first verification result is that a region does not pass the continuity verification, enumerate and verify all the channels of the region.

Disclosed in the present disclosure is a controller, including a memory and a processor. The memory is configured to save a computer program; and the processor is configured to execute the computer program, so as to implement the foregoing method for managing non-transparent bridge.

Disclosed in the present disclosure is a non-transitory computer-readable storage medium, which is configured to save a computer program. The computer program, when being executed by a processor, implements the method for managing foregoing non-transparent bridge.

### BRIEF DESCRIPTION OF THE DRAWINGS

In order to more clearly illustrate the embodiments of the present disclosure or the technical solutions in the related art, the drawings used in the description of the embodiments or the related art will be briefly described below. It is apparent that the drawings in the following descriptions are merely the embodiments of the present disclosure. Other drawings may be obtained from those skilled in the art according to the provided drawings without any creative work.

FIG. 1 is a flowchart of a method for managing non-transparent bridge according to embodiments of the present disclosure.

FIG. 2 is a schematic structural diagram of an optional dual controller memory system according to embodiments of the present disclosure.

FIG. 3 is a flowchart of an optional method for managing non-transparent bridge according to embodiments of the present disclosure.

FIG. 4 is a flowchart of optional data backup according to embodiments of the present disclosure.

FIG. 5 is a flowchart of an optional partition enumeration scanning algorithm according to embodiments of the present disclosure.

FIG. 6 is a flowchart of an optional Hash principle-based data comparison algorithm according to embodiments of the present disclosure.

FIG. 7 is a schematic structural diagram of an apparatus for managing non-transparent bridge according to embodiments of the present disclosure.

FIG. 8 is a diagram of a principle structure of a controller according to embodiments of the present disclosure.

### DETAILED DESCRIPTION OF THE EMBODIMENTS

The technical solutions in the embodiments of the present disclosure will be clearly and completely described below in combination with the drawings in the embodiments of the present disclosure. It is apparent that the described embodiments are only part of the embodiments of the present disclosure, not all the embodiments. All other embodiments obtained by those of ordinary skill in the art on the basis of the embodiments in the present disclosure without creative work all fall within the scope of protection of the present disclosure.

In related art, in a process of using a non-transparent bridge chip to realize data backup, a controller is connected to the NTB chip for data transmission through a PCIE channel. During PCIE serial data transmission, a plurality of channels connected to the NTB are difficult to verify and manage. When a PCIE link is abnormal, the abnormal problem is difficult to position and analyze, and an abnormal channel may lead to errors during data backup of a controller, thus finally resulting in errors in data storage, or even serious problems such as disk missing. Furthermore, as a current PCIE technology develops, bandwidths required for transmitting and backing up data are gradually increased, and with the complexity of storage mainboard functions, a length of a data transmission channel is also prolonged to a certain extend. All of these physical factors make it more difficult to transmit data over the PCIE channel for backup. Therefore, how to accurately perform NTB verification management to ensure an accurate and correct data backup process is an urgent problem to be solved currently. Therefore, the present disclosure provides a solution of managing non-transparent bridge, such that the accuracy of NTB verification management may be improved, thereby ensuring the accuracy of data backup.

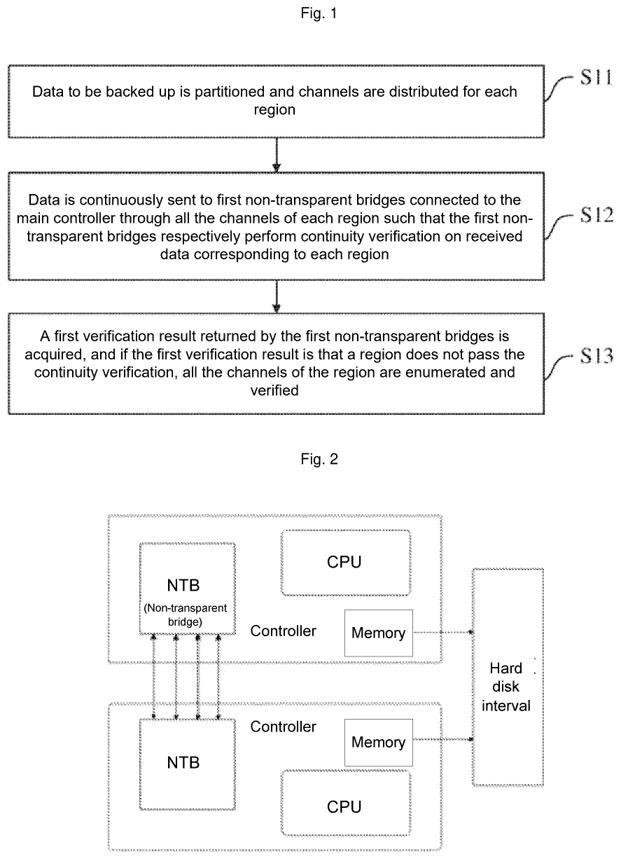

Referring to FIG. 1, disclosed in the embodiments of the present disclosure is a method for managing non-transparent bridge, which is applied to a main controller in a dual controller, and includes the following steps.

At S11, data to be backed up is partitioned and channels are distributed for each region.

For example, referring to FIG. 2, FIG. 2 is a schematic structural diagram of an optional dual controller memory system according to embodiments of the present disclosure. Mutual backup of data between dual controllers is realized through a non-transparent bridge. One controller has 16 PCIE channels connected to the non-transparent bridge, and another controller also has 16 PCIE channels connected to the non-transparent bridge. The two non-transparent bridges are connected to each other, such that the two controllers both may access to each other's systems through the non-transparent bridge, and data may be mutually backed up. PCIE transmits the data by means of serial transmission, such that the starting and ending of data transmission between the channels do not interfere with each other, and each PCIE channel from two controllers to the NTB is independent of each other. Such serial transmission accelerates the rate of data transmission, but the independence of the channels increases the complexity of channel verification, and channel verification may be accurately performed in the embodiments of the present disclosure. The channel is the PCIE channel connecting a Central Processing Unit (CPU) in the controller and the NTB.

In some embodiments of the present disclosure, horizontal partitioning may be performed on the data to be backed up according to the data service object, so as to obtain each region; vertical partitioning is performed on the data to be backed up according to a data importance degree, so as to obtain each vertical partition; and the channels are distributed for each region based on a data volume of each region in each vertical partition. For example, in some embodiments of the present disclosure, vertical partitioning may be performed on the data to be backed up according to the data importance degree, so as to obtain vertical partitions of a high importance degree, a medium importance degree, and a low importance degree. The channels are distributed for each region according to a data volume of each region in these three vertical partitions, and distribution is performed based on a principle of larger data volume of the high importance degree, more channels distributed. If the data volume of the high importance degree is the same, distribution is performed based on a data volume of the medium importance degree. The data service object of each piece of data in the data to be backed up is acquired from the front-end server; and horizontal partitioning is performed on the data to be backed up according to the data service object, so as to obtain each region.

The data to be backed up is data currently processed by the controller, that is, the controller first partition the currently-processed data, a partition manner uses a combination of horizontal partitioning and vertical partitioning, the horizontal partitioning is to horizontally partition the processed data according to the data service object, and the data service object is an object served by the data and is provided by the front-end server. Distribution of the processed data and the data service object is performed by the controller, and after distribution, the region in which each data service object is located corresponds to respective piece of processed data. The vertical partitioning is to vertically partition the processed data into high, medium, and low regions according to the importance degrees, and each region includes certain amount of the processed data. After partitioning, PCIE channel distribution is performed on each region. The channels are distributed according to the previous horizontal partitioning situation, and if 5 data service objects are included, there are 5 regions. The number of channels distributed for each region is divided according to the data importance degree in the vertical partitioning, and if data of a service object includes a large number of high importance degrees, more PCIE channels need to be distributed.

At S12, data is continuously sent to first non-transparent bridges connected to the main controller through all the channels of each region such that the first non-transparent bridges respectively perform continuity verification on received data corresponding to each region.

At S13, a first verification result returned by the first non-transparent bridges is acquired, and if the first verification result is that a region does not pass the continuity verification, all the channels of the region are enumerated and verified.

In some embodiments of the present disclosure, the data is continuously sent to the first non-transparent bridges connected to the main controller one by one through the channels of the region such that the first non-transparent bridges respectively perform the continuity verification on the received data corresponding to each region. That is, the data is continuously sent to the first non-transparent bridges one by one through the channels of the region such that the first non-transparent bridges perform the continuity verification on the received data, so as to position a problematic channel, and the problematic channel is cut off and isolated.

It may be seen that, in the embodiments of the present disclosure, first, the data to be backed up is partitioned and the channels are distributed for each region; then the data is continuously sent to the first non-transparent bridges connected to the main controller through all the channels of each region such that the first non-transparent bridges respectively perform continuity verification on the received data corresponding to each region; and then the first verification result returned by the first non-transparent bridges is acquired, and if the first verification result is that the region does not pass the continuity verification, all the channels of the region are enumerated and verified. That is, in the present disclosure, before data backup, the data to be backed up is partitioned and the channels are distributed, then each region is verified first, and if a region does not pass the verification, each channel is verified. In this way, a problematic channel connected to a non-transparent bridge may be accurately verified, such that the problem is processed in a timely manner, and the accuracy and efficiency of non-transparent bridge verification management may be improved, thereby ensuring the accuracy of data backup.

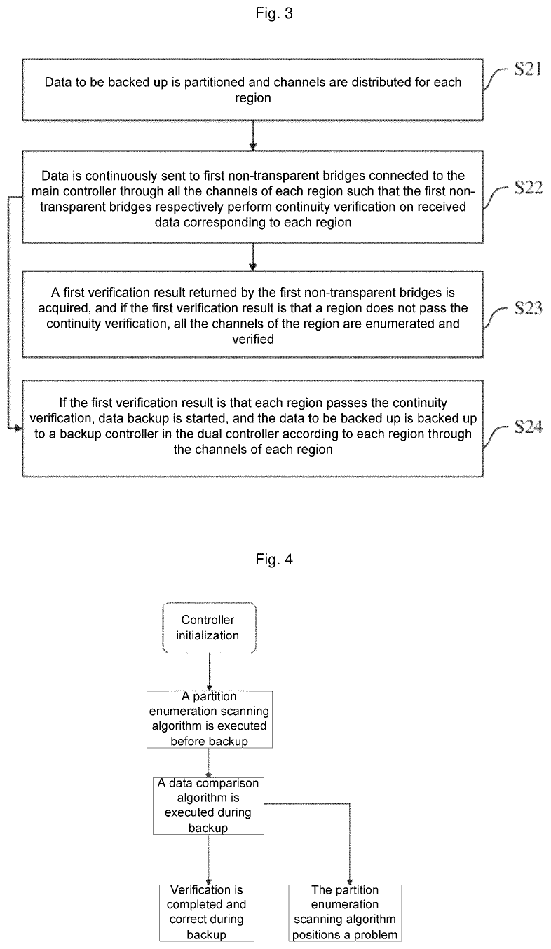

Referring to FIG. 3, disclosed in the embodiments of the present disclosure is an optional method for managing non-transparent bridge, which is applied to a main controller in a dual controller, and includes the following steps.

At S21, data to be backed up is partitioned and channels are distributed for each region.

At S22, data is continuously sent to first non-transparent bridges connected to the main controller through all the channels of each region such that the first non-transparent bridges respectively perform continuity verification on received data corresponding to each region.

At S23, a first verification result returned by the first non-transparent bridges is acquired, and if the first verification result is that a region does not pass the continuity verification, all the channels of the region are enumerated and verified.

Implementations of S21 to S23 may be referred to content disclosed in the foregoing embodiments, and are not described herein again.

At S24, if the first verification result is that each region passes the continuity verification, data backup is started, and the data to be backed up is backed up to a backup controller in the dual controller according to each region through the channels of each region.

That is, after the channels are distributed, the controller sends the same continuous message data to the NTB through the channels of each region. The NTB verifies the continuity of the message data in each region in real time. If it is detected that the continuity of the data in each region meets the requirements, the verification is completed, a data backup operation is started; and when it is detected that the continuity of the data is abnormal, the NTB may position a region rapidly. Then the channels of the region are enumerated and verified; diagnostic information is sent to the controller after the problematic channel is verified; and the channel is cut off and isolated on software during data backup.

Furthermore, in some embodiments of the present disclosure, a partition and channel distribution situation may be sent to the backup controller such that the backup controller continuously sends data to second non-transparent bridges connected to the backup controller through all the channels of each region based on the partition and channel distribution situation, so as to cause the second non-transparent bridges to respectively perform the continuity verification on the received data corresponding to each region, and to enumerate and verify all the channels of a region when a second verification result returned by the second non-transparent bridges is that the region does not pass the continuity verification. Accordingly, in some embodiments of the present disclosure, if the first verification result is that each region passes the continuity verification, and the second verification result is that each region passes the continuity verification, data backup is started.

That is, in order to ensure that NTBs on two controllers on a backup link may all be available, in some embodiments of the present disclosure, channel verification before backup is also performed on the backup controller side, and a manner may be referred to the verification in the main controller. Furthermore, in some embodiments of the present disclosure, the main controller and the backup controller in the dual controller are not fixed, the main controller is a controller in which the data to be backed up is located during backup, and the backup controller is a controller to which the data to be backed up is backed up.

In some embodiments of the present disclosure, the data to be backed up may be batched to obtain a plurality of pieces of batch data, and the plurality of pieces of batch data are backed up to the backup controller in the dual controller batch by batch according to each region through the channels of each region. Correspondingly, after any batch data is backed up, a first feature of the batch data is extracted, and the first feature is transmitted to the first non-transparent bridge such that the first non-transparent bridge compares whether the first feature is consistent with a second feature, where the second feature is a second feature of the batch data received by the backup controller extracted by the backup controller.

In some embodiments of the present disclosure, extracting the first feature of the batch data includes the following steps.

At S00, a Hash Function Is Determined.

In some embodiments of the present disclosure, a data type of the batch data may be recognized; and the hash function is determined based on the data type.

The data type includes a text type, an image type, and a video type, and accordingly, determining the hash function based on the data type includes: a first hash function is constructed based on a division method; a hash function of the text type is determined as the first hash function; a second hash function is constructed based on a square median method; and hash functions of the image type and the video type are determined as the second hash functions.

At S01, the hash function is used to extract a hashed value set of the batch data, so as to obtain the first feature of the batch data.

In some embodiments of the present disclosure, for any data type of data in the batch data, a hashed value may be extracted by using the hash function corresponding to the data type; and hashed values corresponding to different data types are fused into the hashed value set of the batch data, so as to obtain the first feature of the batch data.

Furthermore, the main controller may send an execution instruction to the backup controller such that the backup controller extracts the second feature of the received batch data under control of the execution instruction. The backup controller and the main controller perform feature extraction at the same time under the control of the execution instruction, the backup controller obtains the second feature, and the main controller obtains the first feature. An extraction process of the second feature may be referred to an extraction process of the first feature, and thus is not described herein again. The main controller acquires the second feature sent by the backup controller; and the second feature is transmitted to the first non-transparent bridge such that the first non-transparent bridge compares whether the first feature is consistent with a second feature.

That is, in some embodiments of the present disclosure, the hashed value set is constructed for the processed data based on the Hash principle, and a data volume of the hashed value set is far less than an original processed data volume, such that raw data may be compared with backup data within the shortest time. The premise of the construction of the hashed value set is to select an appropriate hash function to cause the raw data to be in a many-to-one relationship with hash data that is subjected to hash function mapping, such that the volume of the processed data is greatly reduced. The hashed value set mapped by the hash function in a mapping process needs to meet two conditions: 1, a total data volume is far less than a total volume of the original processed data; and 2, the data in the hashed value set may reflect the overall situation of the raw data. In some embodiments of the present disclosure, a mixed hash function method is used, that is, different hash functions are selected for different data types, and finally, the obtained sets are fused to obtain a final hash set. For example, the division method is selected for the data of the text type. A remainder after a test data segment is divided by a keyword P is used as a hashed value, where P is a prime number less than a length of the data segment. This method may greatly reserve features of the raw data while reducing the data volume, and thus is suitable for data with relatively low complexity. The square median method may be used for complex binary data such as images, videos, etc. Continuous data is squared, and the middle few numbers (i.e., a median and preset numbers neighboring the median) of the obtained data are selected after squaring, such that a small number of feature values are extracted from the continuous data segment, so as to realize dimension reduction of data processed by the controller.

In some embodiments of the present disclosure, if the first feature is consistent with the second feature, the backup of a next piece of batch data continues; and if the first feature is inconsistent with the second feature, the problematic channel is determined and closed, and a data migration task of the problematic channel is distributed to other channels of the region. The process of determining the problematic channel includes: data is continuously sent to the first non-transparent bridges connected to the main controller through all the channels of each region such that the first non-transparent bridges respectively perform the continuity verification on the received data corresponding to each region; and a verification result returned by the first non-transparent bridges is acquired, if the verification result is that a region does not pass the continuity verification, all the channels of the region are enumerated and verified, and a channel that does not pass the verification is determined as the problematic channel.

Furthermore, the first feature may also be sent to the backup controller, and the second non-transparent bridge in the backup controller compares whether the first feature is consistent with a second feature, and simultaneously performs problem position of the channel corresponding to the second non-transparent bridge. That is, the two controllers position the problematic channel at the same time.

The process of determining the problematic channel in the backup controller includes: data is continuously sent to the second non-transparent bridges connected to the backup controller through all the channels of each region such that the second non-transparent bridges respectively perform continuity verification on received data corresponding to each region. A verification result returned by the second non-transparent bridges is acquired, and if the verification result is that a region does not pass the continuity verification, all the channels of the region are enumerated and verified.

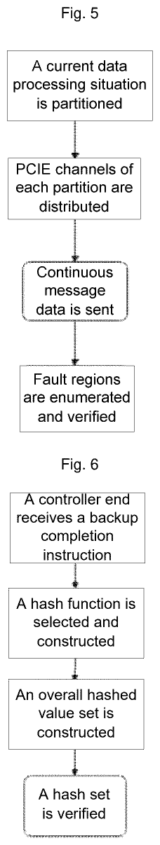

For example, referring to FIG. 4, FIG. 4 is a flowchart of optional data backup according to embodiments of the present disclosure. Data verification and channel management between the PCIE channels from the CPU to the NTB through a partition enumeration scanning algorithm. The data backup operation is started after the verification is correct. The Hash principle-based data comparison algorithm is used during data backup, the CPU end of the dual controller uses the algorithm to perform rapid feature extraction verification on the backup data, so as to ensure the data during transmission is valid. When the algorithm detects an error in data backup during data backup, the partition enumeration scanning algorithm is started for the second time, and the algorithm may rapidly position the abnormal PCIE channel, and an instruction that the data is wrongly transmitted is sent to a Baseboard Management Controller (BMC) control unit as abnormal log collection of a system, but the secondary starting does not perform partitioning and channel distribution, and the channels that have been distributed before backup are verified. That is, the partition enumeration scanning algorithm performs the verification treatment on each PCIE channel at a NTB level. The algorithm is executed to determine the integrity of each channel before data backup, and is executed during problem positioning and analysis to rapidly position a problematic channel, such that a rapid NTB verification management operation is realized through the algorithm. It may be understood that, the partition enumeration scanning algorithm may execute the following steps: before data backup, the data to be backed up is partitioned and the channels are distributed for each region; the data is continuously sent to the first non-transparent bridges connected to the main controller through the channels of each region such that the first non-transparent bridges respectively perform continuity verification on the received data corresponding to each region; and the first verification result returned by the first non-transparent bridges is acquired, and if the first verification result is that a region does not pass the continuity verification, all the channels of the region are enumerated and verified. For example, referring to FIG. 5, FIG. 5 is a flowchart of an optional partition enumeration scanning algorithm according to embodiments of the present disclosure. Furthermore, the data comparison algorithm may be executed to extract, after any batch data is backed up, a first feature of the batch data, and transmit the first feature to the first non-transparent bridge such that the first non-transparent bridge compares whether the first feature is consistent with a second feature, where the second feature is a second feature of the batch data received by the backup controller extracted by the backup controller. In this way, the CPU of the controller performs feature extraction on real-time data during data backup, so as to perform timely verification on the extracted feature data, thereby ensuring the accuracy of data backup. In one data backup process, that is, after one piece of batch data is backed up, the main controller end sends the algorithm execution instruction to the backup controller end, the dual controller simultaneously performs the data comparison algorithm, finally, the dual controller transmits the hash sets obtained by the execution algorithm to the non-transparent bridge, and the non-transparent bridge verifies whether the hash sets are completely consistent with each other. For example, referring to FIG. 6, FIG. 6 is a flowchart of an optional Hash principle-based data comparison algorithm according to embodiments of the present disclosure.

That is, embodiments of the present disclosure provide solutions of verification management before the NTB operates normally, as well as data verification diagnosis and abnormal processing during NTB operation. The verification portion before the NTB operates normally is intended to ensure the NTB operates normally from a main path to each passageway end converted, such that the two controllers may normally back up data through the NTB channels. The channels on the NTB are partitioned and managed according to functions through the partition enumeration scanning algorithm, and the normal operation of the channels of each region is ensured through the enumeration algorithm. After the NTB operates normally, a feature portion of verification data is rapidly extracted through the Hash principle-based data comparison algorithm, and the accuracy of mirror backup data is verified. The execution of the algorithm is accompanied by the completion of one batch of data backup in data mirror backup between the dual controllers, so as to ensure that backup continues after the verification is correct, thereby greatly avoid an error rate of data backup on the NTB. When it is found that the data is inconsistent during execution of the algorithm, a diagnosis process is started timely. The diagnosis process is based on the partition enumeration scanning algorithm executed before the NTB operates, and positions a problematic NTB operation region, so as to scan the problematic channel through enumeration. A data processing process on the channel is timely closed on software, a data transmission task on the channel is transferred to other channels in the region, and an instruction that the data is wrongly transmitted is sent to a BMC control unit as abnormal log collection of a system. In this way, an NTB channel verification operation before backup may be completed rapidly, such that an appropriate response may be timely made when an abnormal problem occurs, so as to minimize the impact of an abnormal situation, thereby improving the high efficiency of a data backup channel of a memory system and the safety and reliability of system operation.

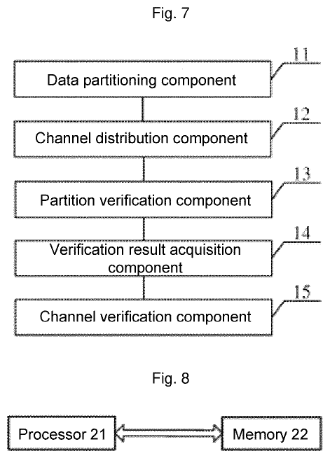

Referring to FIG. 7, disclosed in the embodiments of the present disclosure is an apparatus for managing non-transparent bridge, which is applied to a main controller in a dual controller, and includes a data partitioning component, a channel distribution component, a partition verification component, a verification result acquisition component, and a channel verification component.

The data partitioning component 11 is configured to partition data to be backed up.

The channel distribution component 12 is configured to distribute channels for each region.

The partition verification component 13 is configured to continuously send data to first non-transparent bridges connected to the main controller through all the channels of each region such that the first non-transparent bridges respectively perform continuity verification on received data corresponding to each region.

The verification result acquisition component 14 is configured to acquire a first verification result returned by the first non-transparent bridges.

The channel verification component 15 is configured to, if the first verification result is that a region does not pass the continuity verification, enumerate and verify all the channels of the region.

It may be seen that, in the embodiments of the present disclosure, first, the data to be backed up is partitioned and the channels are distributed for each region; then the data is continuously sent to the first non-transparent bridges connected to the main controller through all the channels of each region such that the first non-transparent bridges respectively perform continuity verification on the received data corresponding to each region; and then the first verification result returned by the first non-transparent bridges is acquired, and if the first verification result is that the region does not pass the continuity verification, all the channels of the region are enumerated and verified. That is, in the present disclosure, before data backup, the data to be backed up is partitioned and the channels are distributed, then each region is verified first, and if a region does not pass the verification, each channel is verified. In this way, a problematic channel connected to a non-transparent bridge may be accurately verified, such that the problem is processed in a timely manner, and the accuracy and efficiency of non-transparent bridge verification management may be improved, thereby ensuring the accuracy of data backup.

In some embodiments of the present disclosure, the data partitioning component 11 is configured to perform horizontal partitioning on the data to be backed up according to a data service object, so as to obtain each region; and perform vertical partitioning on the data to be backed up according to a data importance degree, so as to obtain each vertical partition. Accordingly, the channel distribution component 12 is configured to distribute the channels for each region based on a data volume of each region in each vertical partition. The data partitioning component 11 is further configured to acquire the data service object from a front-end server. The channel distribution component 12 is configured to continuously send the data to the first non-transparent bridges connected to the main controller one by one through the channels of the region such that the first non-transparent bridges respectively perform the continuity verification on the received data corresponding to each region.

In some embodiments of the present disclosure, the apparatus further includes a data backup component, which is configured to, if the first verification result is that each region passes the continuity verification, start data backup, and back up the data to be backed up to a backup controller in the dual controller according to each region through the channels of each region.

In some embodiments of the present disclosure, the apparatus further includes a partition and channel distribution situation sending component, which is configured to, after partitioning the data to be backed up and distributing the channels for each region, send a partition and channel distribution situation to the backup controller such that the backup controller continuously sends data to second non-transparent bridges connected to the backup controller through all the channels of each region based on the partition and channel distribution situation, so as to cause the second non-transparent bridges to respectively perform the continuity verification on the received data corresponding to each region, and to enumerate and verify all the channels of a region when a second verification result returned by the second non-transparent bridges is that the region does not pass the continuity verification. Accordingly, the data backup component is configured to, if the first verification result is that each region passes the continuity verification, and the second verification result is that each region passes the continuity verification, start data backup.

In some embodiments of the present disclosure, the data backup component is configured to batch the data to be backed up to obtain a plurality of pieces of batch data, and back up the plurality of pieces of batch data to the backup controller in the dual controller batch by batch according to each region through the channels of each region.

Accordingly, the apparatus further includes a first feature extraction component and a first feature transmission component.

The first feature extraction component is configured to, after any batch data is backed up, extract a first feature of the batch data.

The first feature transmission component is configured to transmit the first feature to the first non-transparent bridge such that the first non-transparent bridge compares whether the first feature is consistent with a second feature.

The second feature is a second feature of the batch data received by the backup controller extracted by the backup controller.

Furthermore, the apparatus further includes an execution instruction sending component, which is configured to send an execution instruction to the backup controller such that the backup controller extracts the second feature of the received batch data under control of the execution instruction.

In some embodiments of the present disclosure, the apparatus further includes a feature acquisition component, which is configured to acquire the second feature sent by the backup controller.

A second feature transmission component is configured to transmit the second feature to the first non-transparent bridge such that the first non-transparent bridge compares whether the first feature is consistent with the second feature.

In some embodiments of the present disclosure, the apparatus further includes a problematic channel determination component and a problem processing component.

The problematic channel determination component is configured to, if the first feature is inconsistent with the second feature, determine a problematic channel.

The problem processing component is configured to close the problematic channel.

The problematic channel determination component is configured to continuously send data to the first non-transparent bridges connected to the main controller through all the channels of each region such that the first non-transparent bridges respectively perform the continuity verification on the received data corresponding to each region; and acquire a verification result returned by the first non-transparent bridges, if the verification result is that a region does not pass the continuity verification, enumerate and verify all the channels of the region, and determine a channel that does not pass the verification as the problematic channel.

In some embodiments of the present disclosure, the problematic channel determination component includes the foregoing partition verification component, verification result acquisition component, and channel verification component.

In some embodiments of the present disclosure, the first feature extraction component includes a hash function determination sub-component and a first feature extraction sub-component.

The hash function determination sub-component is configured to determine a hash function.

The first feature extraction sub-component is configured to use the hash function to extract a hashed value set of the batch data, so as to obtain the first feature of the batch data.

The hash function determination sub-component includes a data type recognition unit and a hash function determination unit.

The data type recognition unit is configured to recognize a data type of the batch data.

The hash function determination unit is configured to determine the hash function based on the data type.

The first feature extraction sub-component includes a hashed value extraction unit and a hashed value fusion unit.

The hashed value extraction unit is configured to, for any data type of data in the batch data, extract a hashed value by using the hash function corresponding to the data type.

The hashed value fusion unit is configured to fuse hashed values corresponding to different data types into the hashed value set of the batch data, so as to obtain the first feature of the batch data.

In some embodiments of the present disclosure, the data type includes a text type, an image type, and a video type, and accordingly, the hash function determination unit is configured to construct a first hash function based on a division method; determine a hash function of the text type as the first hash function; construct a second hash function based on a square median method; and determine hash functions of the image type and the video type as the second hash functions.

Referring to FIG. 8, disclosed in the embodiments of the present disclosure is a controller, including a processor 21 and a memory 22. The memory 22 is configured to save a computer program; and the processor 21 is configured to execute the computer program to implement the following steps.

Data to be backed up is partitioned and channels are distributed for each region; data is continuously sent to first non-transparent bridges connected to a main controller through all the channels of each region such that the first non-transparent bridges respectively perform continuity verification on received data corresponding to each region; and a first verification result returned by the first non-transparent bridges is acquired, and if the first verification result is that a region does not pass the continuity verification, all the channels of the region are enumerated and verified.

It may be seen that, in the embodiments of the present disclosure, first, the data to be backed up is partitioned and the channels are distributed for each region; then the data is continuously sent to the first non-transparent bridges connected to the main controller through all the channels of each region such that the first non-transparent bridges respectively perform continuity verification on the received data corresponding to each region; and then the first verification result returned by the first non-transparent bridges is acquired, and if the first verification result is that the region does not pass the continuity verification, all the channels of the region are enumerated and verified. That is, in the present disclosure, before data backup, the data to be backed up is partitioned and the channels are distributed, then each region is verified first, and if a region does not pass the verification, each channel is verified. In this way, a problematic channel connected to a non-transparent bridge may be accurately verified, such that the problem is processed in a timely manner, and the accuracy and efficiency of non-transparent bridge verification management may be improved, thereby ensuring the accuracy of data backup.

In some embodiments of the present disclosure, when the processor 21 executes a computer subprogram saved in the memory 22, the following steps may be implemented: horizontal partitioning is performed on the data to be backed up according to the data service object, so as to obtain each region; vertical partitioning is performed on the data to be backed up according to a data importance degree, so as to obtain each vertical partition; and the channels are distributed for each region based on a data volume of each region in each vertical partition.

In some embodiments of the present disclosure, when the processor 21 executes the computer subprogram saved in the memory 22, the following steps may be implemented: if the first verification result is that each region passes the continuity verification, data backup is started, and the data to be backed up is backed up to a backup controller in the dual controller according to each region through the channels of each region.

In some embodiments of the present disclosure, when the processor 21 executes the computer subprogram saved in the memory 22, the following steps may be implemented: after partitioning the data to be backed up and distributing the channels for each region, a partition and channel distribution situation is sent to the backup controller such that the backup controller continuously sends data to second non-transparent bridges connected to the backup controller through all the channels of each region based on the partition and channel distribution situation, so as to cause the second non-transparent bridges to respectively perform the continuity verification on the received data corresponding to each region, and to enumerate and verify all the channels of a region when a second verification result returned by the second non-transparent bridges is that the region does not pass the continuity verification.

In some embodiments of the present disclosure, when the processor 21 executes the computer subprogram saved in the memory 22, the following steps may be implemented: if the first verification result is that each region passes the continuity verification, and the second verification result is that each region passes the continuity verification, data backup is started.

In some embodiments of the present disclosure, when the processor 21 executes the computer subprogram saved in the memory 22, the following steps may be implemented: the data to be backed up is batched to obtain a plurality of pieces of batch data, and the plurality of pieces of batch data are backed up to the backup controller in the dual controller batch by batch according to each region through the channels of each region.

In some embodiments of the present disclosure, when the processor 21 executes the computer subprogram saved in the memory 22, the following steps may be implemented: after any batch data is backed up, a first feature of the batch data is extracted, and the first feature is transmitted to the first non-transparent bridge such that the first non-transparent bridge compares whether the first feature is consistent with a second feature, where the second feature is a second feature of the batch data received by the backup controller extracted by the backup controller.

In some embodiments of the present disclosure, when the processor 21 executes the computer subprogram saved in the memory 22, the following steps may be implemented: an execution instruction is sent to the backup controller such that the backup controller extracts the second feature of the received batch data under control of the execution instruction.

In some embodiments of the present disclosure, when the processor 21 executes the computer subprogram saved in the memory 22, the following steps may be implemented: if the first feature is inconsistent with the second feature, a problematic channel is determined, and the problematic channel is closed.

In some embodiments of the present disclosure, when the processor 21 executes the computer subprogram saved in the memory 22, the following steps may be implemented: a hash function is determined; and the hash function is used to extract a hashed value set of the batch data, so as to obtain the first feature of the batch data.

In some embodiments of the present disclosure, when the processor 21 executes the computer subprogram saved in the memory 22, the following steps may be implemented: a data type of the batch data is recognized; and the hash function is determined based on the data type.

In some embodiments of the present disclosure, when the processor 21 executes the computer subprogram saved in the memory 22, the following steps may be implemented: for any data type of data in the batch data, a hashed value may be extracted by using the hash function corresponding to the data type; and hashed values corresponding to different data types are fused into the hashed value set of the batch data, so as to obtain the first feature of the batch data.

In some embodiments of the present disclosure, when the processor 21 executes the computer subprogram saved in the memory 22, the following steps may be implemented: a first hash function is constructed based on a division method; a hash function of the text type is determined as the first hash function; a second hash function is constructed based on a square median method; and hash functions of the image type and the video type are determined as the second hash functions.

Furthermore, as a carrier for resource storage, the memory 22 may be a read-only memory, a random memory, a disk or optical disk, etc., and a storage mode may be transient or permanent.

In some embodiments of the present disclosure, disclosed in the embodiments of the present disclosure is a non-transitory computer-readable storage medium, which is configured to save a computer program. The computer program, when being executed by a processor, implements the following steps.

Data to be backed up is partitioned and channels are distributed for each region; data is continuously sent to first non-transparent bridges connected to a main controller through all the channels of each region such that the first non-transparent bridges respectively perform continuity verification on received data corresponding to each region; and a first verification result returned by the first non-transparent bridges is acquired, and if the first verification result is that a region does not pass the continuity verification, all the channels of the region are enumerated and verified.

It may be seen that, in the embodiments of the present disclosure, first, the data to be backed up is partitioned and the channels are distributed for each region; then the data is continuously sent to the first non-transparent bridges connected to the main controller through all the channels of each region such that the first non-transparent bridges respectively perform continuity verification on the received data corresponding to each region; and then the first verification result returned by the first non-transparent bridges is acquired, and if the first verification result is that the region does not pass the continuity verification, all the channels of the region are enumerated and verified. That is, in the present disclosure, before data backup, the data to be backed up is partitioned and the channels are distributed, then each region is verified first, and if a region does not pass the verification, each channel is verified. In this way, a problematic channel connected to a non-transparent bridge may be accurately verified, such that the problem is processed in a timely manner, and the accuracy and efficiency of non-transparent bridge verification management may be improved, thereby ensuring the accuracy of data backup.

In some embodiments of the present disclosure, when a computer subprogram saved in the non-transitory computer-readable storage medium is executed, the following steps may be implemented: horizontal partitioning is performed on the data to be backed up according to the data service object, so as to obtain each region; vertical partitioning is performed on the data to be backed up according to a data importance degree, so as to obtain each vertical partition; and the channels are distributed for each region based on a data volume of each region in each vertical partition.

In some embodiments of the present disclosure, when a computer subprogram saved in the non-transitory computer-readable storage medium is executed, the following steps may be implemented: if the first verification result is that each region passes the continuity verification, data backup is started, and the data to be backed up is backed up to a backup controller in the dual controller according to each region through the channels of each region.

In some embodiments of the present disclosure, when a computer subprogram saved in the non-transitory computer-readable storage medium is executed, the following steps may be implemented: after partitioning the data to be backed up and distributing the channels for each region, a partition and channel distribution situation is sent to the backup controller such that the backup controller continuously sends data to second non-transparent bridges connected to the backup controller through all the channels of each region based on the partition and channel distribution situation, so as to cause the second non-transparent bridges to respectively perform the continuity verification on the received data corresponding to each region, and to enumerate and verify all the channels of a region when a second verification result returned by the second non-transparent bridges is that the region does not pass the continuity verification.

In some embodiments of the present disclosure, when a computer subprogram saved in the non-transitory computer-readable storage medium is executed, the following steps may be implemented: if the first verification result is that each region passes the continuity verification, and the second verification result is that each region passes the continuity verification, data backup is started.

In some embodiments of the present disclosure, when a computer subprogram saved in the non-transitory computer-readable storage medium is executed, the following steps may be implemented: the data to be backed up is batched to obtain a plurality of pieces of batch data, and the plurality of pieces of batch data are backed up to the backup controller in the dual controller batch by batch according to each region through the channels of each region.

In some embodiments of the present disclosure, when a computer subprogram saved in the non-transitory computer-readable storage medium is executed, the following steps may be implemented: after any batch data is backed up, a first feature of the batch data is extracted, and the first feature is transmitted to the first non-transparent bridge such that the first non-transparent bridge compares whether the first feature is consistent with a second feature, where the second feature is a second feature of the batch data received by the backup controller extracted by the backup controller.

In some embodiments of the present disclosure, when a computer subprogram saved in the non-transitory computer-readable storage medium is executed, the following steps may be implemented: an execution instruction is sent to the backup controller such that the backup controller extracts the second feature of the received batch data under control of the execution instruction.

In some embodiments of the present disclosure, when a computer subprogram saved in the non-transitory computer-readable storage medium is executed, the following steps may be implemented: if the first feature is inconsistent with the second feature, a problematic channel is determined, and the problematic channel is closed.

In some embodiments of the present disclosure, when a computer subprogram saved in the non-transitory computer-readable storage medium is executed, the following steps may be implemented: a hash function is determined; and the hash function is used to extract a hashed value set of the batch data, so as to obtain the first feature of the batch data.

In some embodiments of the present disclosure, when a computer subprogram saved in the non-transitory computer-readable storage medium is executed, the following steps may be implemented: a data type of the batch data is recognized; and the hash function is determined based on the data type.

In some embodiments of the present disclosure, when a computer subprogram saved in the non-transitory computer-readable storage medium is executed, the following steps may be implemented: for any data type of data in the batch data, a hashed value may be extracted by using the hash function corresponding to the data type; and hashed values corresponding to different data types are fused into the hashed value set of the batch data, so as to obtain the first feature of the batch data.

In some embodiments of the present disclosure, when a computer subprogram saved in the non-transitory computer-readable storage medium is executed, the following steps may be implemented: a first hash function is constructed based on a division method; a hash function of the text type is determined as the first hash function; a second hash function is constructed based on a square median method; and hash functions of the image type and the video type are determined as the second hash functions.

Each embodiment in this specification is described in a progressive manner, and each embodiment focuses on the differences from other embodiments, and the same or similar parts of each embodiment may be referred to each other. For the apparatus disclosed in the embodiments, since the apparatus corresponds to the method disclosed in the embodiments, the description is relatively simple, and for related parts, refer to the partial descriptions of the method.

The steps of the method or algorithm described in combination with the embodiments disclosed herein may be implemented directly with the hardware, a software component executed by the processor, or a combination of the hardware and the software component. The software component may be provided in the RAM, the memory, the ROM, the electrically programmable ROM, the electrically erasable programmable ROM, the register, the hard disk, a removable disk, a CD-ROM, or any other form of non-transitory readable storage media known in the technical field.

The method and apparatus for managing non-transparent bridge, and controller and non-transitory readable storage medium provided in the embodiments of the present disclosure are described in detail above. Detailed examples are used in this specification to describe the principles and implementations of the present disclosure. The description of the above embodiments is merely used to facilitate understanding of the method and the core idea of the present disclosure. In addition, for those of ordinary skill in the art, according to the idea of the present disclosure, there will be changes in the specific implementations and the scope of application. In summary, the content of this specification should not be construed as a limitation of the present disclosure.

1. A method for managing non-transparent bridge, applied to a main controller in a dual controller, and comprising:
partitioning data to be backed up and distributing channels for each region;
continuously sending data to first non-transparent bridges connected to the main controller through all the channels of each region such that the first non-transparent bridges respectively perform continuity verification on received data corresponding to each region; and
acquiring a first verification result returned by the first non-transparent bridges, and in response to that the first verification result is that a region does not pass the continuity verification, enumerating and verifying all the channels of the region.

2. The method for managing non-transparent bridge as claimed in claim 1, wherein partitioning the data to be backed up and distributing the channels for each region comprises:
performing horizontal partitioning on the data to be backed up according to a data service object, to obtain each region;
performing vertical partitioning on the data to be backed up according to a data importance degree, to obtain each vertical partition; and
distributing the channels for each region based on a data volume of each region in each vertical partition.

3. The method for managing non-transparent bridge as claimed in claim 2, wherein performing horizontal partitioning on the data to be backed up according to the data service object, to obtain each region comprises:
acquiring the data service object from a front-end server; and
performing horizontal partitioning on the data to be backed up according to the data service object, to obtain each region.

4. The method for managing non-transparent bridge as claimed in claim 1, further comprising:
in response to that the first verification result is that each region passes the continuity verification, starting data backup, and backing up the data to be backed up to a backup controller in the dual controller according to each region through the channels of each region.

5. The method for managing non-transparent bridge as claimed in claim 4, wherein after partitioning the data to be backed up and distributing the channels for each region, the method further comprises:
sending a partition and channel distribution situation to the backup controller such that the backup controller continuously sends data to second non-transparent bridges connected to the backup controller through all the channels of each region based on the partition and channel distribution situation, to cause the second non-transparent bridges to respectively perform the continuity verification on the received data corresponding to each region, and to enumerate and verify all the channels of a region when a second verification result returned by the second non-transparent bridges is that the region does not pass the continuity verification.

6. The method for managing non-transparent bridge as claimed in claim 5, wherein in response to that the first verification result is that each region passes the continuity verification, starting data backup comprises:
in response to that the first verification result is that each region passes the continuity verification, and the second verification result is that each region passes the continuity verification, starting data backup.

7. The method for managing non-transparent bridge as claimed in claim 1, wherein enumerating and verifying all the channels of the region comprises:
continuously sending the data to the first non-transparent bridges connected to the main controller one by one through the channels of the region such that the first non-transparent bridges respectively perform the continuity verification on the received data corresponding to each region.

8. The method for managing non-transparent bridge as claimed in claim 4, wherein backing up the data to be backed up to the backup controller in the dual controller according to each region through the channels of each region comprises:
batching the data to be backed up to obtain a plurality of pieces of batch data, and backing up the plurality of pieces of batch data to the backup controller in the dual controller batch by batch according to each region through the channels of each region.

9. The method for managing non-transparent bridge as claimed in claim 8, further comprising:
after any batch data is backed up, extracting a first feature of the batch data, and transmitting the first feature to the first non-transparent bridge such that the first non-transparent bridge compares whether the first feature is consistent with a second feature, wherein
the second feature is a second feature of the batch data received by the backup controller extracted by the backup controller.

10. The method for managing non-transparent bridge as claimed in claim 9, further comprising:
sending an execution instruction to the backup controller such that the backup controller extracts the second feature of received batch data under control of the execution instruction.

11. The method for managing non-transparent bridge as claimed in claim 10, further comprising:
acquiring the second feature sent by the backup controller; and
transmitting the second feature to the first non-transparent bridge such that the first non-transparent bridge compares whether the first feature is consistent with a second feature.

12. The method for managing non-transparent bridge as claimed in claim 9, further comprising:
in response to that the first feature is inconsistent with the second feature, determining a problematic channel, and closing the problematic channel.

13. The method for managing non-transparent bridge as claimed in claim 12, wherein determining the problematic channel comprises:
continuously sending data to the first non-transparent bridges connected to the main controller through all the channels of each region such that the first non-transparent bridges respectively perform the continuity verification on the received data corresponding to each region; and
acquiring a verification result returned by the first non-transparent bridges, in response to that the verification result is that a region does not pass the continuity verification, enumerating and verifying all the channels of the region, and determining a channel that does not pass the verification as the problematic channel.

14. The method for managing non-transparent bridge as claimed in claim 9, wherein extracting the first feature of the batch data comprises:
determining a hash function; and
using the hash function to extract a hashed value set of the batch data, obtain the first feature of the batch data.

15. The method for managing non-transparent bridge as claimed in claim 14, wherein determining the hash function comprises:
recognizing a data type of the batch data; and
determining the hash function based on the data type.

16. The method for managing non-transparent bridge as claimed in claim 15, wherein using the hash function to extract the hashed value set of the batch data, to obtain the first feature of the batch data comprises:
for any data type of data in the batch data, extracting a hashed value by using the hash function corresponding to the data type; and
fusing hashed values corresponding to different data types into the hashed value set of the batch data, to obtain the first feature of the batch data.

17. The method for managing non-transparent bridge as claimed in claim 15, wherein the data type comprises a text type, an image type, and a video type, and accordingly, determining the hash function based on the data type comprises:
constructing a first hash function based on a division method;
determining a hash function of the text type as the first hash function;
constructing a second hash function based on a square median method; and
determining hash functions of the image type and the video type as the second hash functions.

18. (canceled)

19. A controller, comprising a memory and a processor, wherein
the memory is configured to save a computer program; and
the processor is configured to execute the computer program, cause the processor to:
partition data to be backed up and distribute channels for each region;
continuously send data to first non-transparent bridges connected to the main controller through all the channels of each region such that the first non-transparent bridges respectively perform continuity verification on received data corresponding to each region; and
acquire a first verification result returned by the first non-transparent bridges, and in response to that the first verification result is that a region does not pass the continuity verification, enumerate and verify all the channels of the region.

20. A non-transitory computer-readable storage medium, configured to save a computer program, wherein the computer program, when being executed by a processor, cause the processor to:
partition data to be backed up and distribute channels for each region;
continuously send data to first non-transparent bridges connected to the main controller through all the channels of each region such that the first non-transparent bridges respectively perform continuity verification on received data corresponding to each region; and
acquire a first verification result returned by the first non-transparent bridges, and in response to that the first verification result is that a region does not pass the continuity verification, enumerate and verify all the channels of the region.

21. The controller as claimed in claim 19, wherein the processor is further configured to:
perform horizontal partitioning on the data to be backed up according to a data service object, to obtain each region;
perform vertical partitioning on the data to be backed up according to a data importance degree, to obtain each vertical partition; and
distribute the channels for each region based on a data volume of each region in each vertical partition.
